(19) United States
(12) Patent Application Publication
(10) Pub. No.: US 2012/0269563 A1
(43) Pub. Date: Oct. 25, 2012

(54) TRANSPORTING DEVICE AND IMAGE FORMING APPARATUS USING THE SAME

(75) Inventor: Makoto UI, Tokyo (JP)

(73) Assignee: KONICA MINOLTA BUSINESS TECHNOLOGIES, INC., Tokyo (JP)

(21) Appl. No.: 13/440,535

(22) Filed: Apr. 5, 2012

(30) Foreign Application Priority Data
Apr. 25, 2011 (JP) 2011-097359

(51) Int. Cl. G03G 15/00

(52) U.S. Cl. 399/367

(57) ABSTRACT

In a transporting device that transports a sheet of paper which is transporting on a first direction, a control unit has a detection-unit-cleaning mode in which when roller members move to a second direction, which is perpendicular to the first direction, to perform a correction of the positional deflection of the sheet of paper, the control unit controls the roller members to move the sheet of paper to an outside position from an image forming position and a position of the side end of the sheet of paper when the sheet of paper passes through the detection unit, and then to move the sheet of paper to the image forming position, based on the image forming position and the position of a side end of the sheet of paper, which is detected by a detection unit.

### CROSS REFERENCES TO RELATED APPLICATIONS

The present invention contains subject matter related to Japanese Patent Application JP 2011-097359 filed in the Japanese Patent Office on Apr. 25, 2011, the entire contents of which being incorporated herein by reference.

### BACKGROUND OF THE INVENTION

1. Field of the Invention

The present invention relates to a transporting device equipped with a function of an offset correction of a sheet of transporting paper and an image forming apparatus using the same.

2. Description of Related Art

An image forming apparatus equipped with multiple functions, which is simultaneously provided with various functions such as a printer, scanner, a copy machine and a facsimile, has been widely used in recent years. In such an image forming apparatus, a sheet of paper may be deflected to an offset position while the sheet of paper is transported to a secondary transfer unit in which an image is transferred because of mechanical factors or the like in the apparatus. Accordingly, a line sensor that detects a positional deflection of the sheet of paper and a shift roller that corrects the offset position of the sheet of paper are positioned upstream in a transporting route of the secondary transfer unit.

For example, Japanese Patent Application Publication No. 2005-22820 discloses a paper-carrying mechanism and an image forming device using the same in which a line sensor detects a positional deflection of a side end of the sheet of transported paper, a pair of rollers hold the sheet of paper therebetween from the front and back sides thereof and these rollers are slid to move in the paper-width direction by an amount of positional deflection.

Here, in such a paper-carrying mechanism and an image forming apparatus, when a large number of the same sized sheets of paper are processed, there may be a case where any paper dust of the sheets of paper adheres to a contact glass provided on a side of transporting route of the line sensor. The paper dust adhered to the contact glass is normally dust separated from the sheets of paper while it adheres to the sheets of paper when they pass therethrough. If, however, a large amount of paper dust adheres to the sheets of paper, the paper dust remains on the contact glass, particularly, in a many cases, the paper dust remains on the contact glass outside the side end of the sheet of paper passing thereon. This is because the sheets of paper having the same size, which are supplied from the same paper-supplying tray, are transported while they are similarly deflected so that they are passed through the same position, thereby permitting the paper dust to remain on a particular position upon the contact glass. This is also because the side end of each of the sheets of paper always passes through the same position on the line sensor in order to meet the position of the transported sheet of paper with the image forming position finally. Similarly, when an additional print is performed on the sheet of paper having been printed on off-set process, dusting powder such as blocking powder to prevent an image from being invisible up to a back side of the sheet of paper may adhere onto the contact glass.

Such a paper-carrying mechanism and an image forming apparatus have a problem such that the paper dust or the like of the sheet of paper adhered to the contact glass of the line sensor causes the line sensor to erroneously detect the side end of the sheet of paper. FIGS. 1A and 1B show a detected example in which a line sensor 300 normally detects a side end ps of a sheet of paper P. FIGS. 1C and 1D show a detected example in which the line sensor 300 erroneously detects a side end ps of a sheet of paper P by the paper dust. For example, if opposed guide plate which is positioned so as to be opposed to the line sensor 300 is black, as shown in FIG. 1B, a detected output of the sheet of paper exceeds a predetermined threshold value Lth because light is reflected by the sheet of paper P within the sheet of paper P while the detected output of the sheet of paper reduces below the predetermined threshold value Lth because light does not reflected by the opposed guide plate within an outside end from the side end Ps of the sheet of paper P. This enables the line sensor 300 to correctly detect the side end Ps of the sheet of paper P.

On the other hand, if the sheets of paper P pass through the same position of the line sensor 300 in series, the paper dust does not adhere to a range of the contact glass through which the sheets of paper P pass because the sheets of paper P carries the paper dust away. However, as shown in FIG. 1C, a large amount of paper dust B dispersed from the sheets of paper P adheres onto the contact glass just outside the range of the contact glass through which the sheets of paper P pass. This causes the paper dust B dispersed from the sheets of paper P to adhere to a portion D of the contact glass outside from the side end Ps of the sheet of paper P. Thus, as shown in FIG. 1D, light is reflected by the adhered paper dust B, which may cause the detected output of the sheet of paper to exceed the predetermined threshold value Lth. In this moment, the line sensor 300 erroneously detects the portion D of the contact glass outside from the side end Ps of the sheet of paper P as a side end Ps of a sheet of paper P. Therefore, it has a problem such that the line sensor 300 cannot correctly identify the side end Ps of the sheet of paper P.

In order to prevent such an error detection, for example, Japanese Patent No. 3758418 discloses an image recorder. This image recorder is provided with an offset detection sensor in response to an upper paper guide plate, which is openable and closable, and when opening the upper paper guide plate, the contact glass provided on the offset detection sensor is exposed to outside, so that the contact glass is easily cleanable.

### SUMMARY OF THE INVENTION

The past transporting device and the past image forming apparatus, which have been disclosed in Japanese Patent Application Publication No. 2005-22820, have a configuration such that the sheet of paper is moved with it being held between the roller members, however, do not disclose any cleaning of the paper dust adhered onto the contact glass of the line sensor. Therefore, the past transporting device and the past image forming apparatus, which have been disclosed in Japanese Patent Application Publication No. 2005-22820, have failed to prevent the line sensor from erroneously detecting the side end of the sheet of paper.

The past image recorder disclosed in Japanese Patent No. 3758418 has such a mechanism that the upper paper guide plate provided with the offset detection sensor is openable and closable, which adds a new mechanical configuration. Thus, it has a problem such that a design is complicated, which causes to be increased the costs in manufacture. Further, it has a problem such that, in the image recorder, the paper guide plate is opened or closed by hand in a cleaning time so that the operation is inconvenience.

This invention solves the above-mentioned problems and has objects to provide a transporting device and an image forming apparatus using the same, which are possible to automatically clean the paper dust of the sheets of paper adhered to the detection unit and to effectively prevent any error detection of the side end of the sheet of paper by the paper dust adhered to the detection unit without adding any new mechanical configuration.

To achieve at least one of the above-mentioned objects, a transporting device reflecting one aspect of the present invention comprises a detection unit that detects a side end of the sheet of paper, which is transporting on a first direction, along a second direction which is perpendicular to the first direction, a control unit that calculates information on a positional deflection from a previously set image forming position of the sheet of paper based on positional information on the side end of the sheet of paper, which is detected by the detection unit, an image being formed on the image forming position, and positional information on the image forming position, and roller members that move to the second direction with the sheet of paper being held between them based on the information on the positional deflection, which is calculated by the control unit, the roller members being positioned upstream to the detection unit along a direction of transporting the sheet of paper, wherein the control unit has a detection-unit-cleaning mode in which when the roller members move to the second direction to perform a correction of the positional deflection of the sheet of paper, the control unit controls the roller members to move the sheet of paper to an outside position from the image forming position and a position of the side end of the sheet of paper when the sheet of paper passes through the detection unit, and then to move the sheet of paper to the image forming position, based on the image forming position and the position of the side end of the sheet of paper, which is detected by the detection unit.

It is desirable to provide the transporting device wherein the detection unit has a cover member that is positioned at a side of a transporting route of the sheet of paper, and the roller members move the sheet of paper with the sheet of paper being held therebetween so that the sheet of paper comes into contact with the cover member or is close to the cover member when moving the sheet of paper to the second direction.

It is desirable to provide the transporting device wherein when a printing job is a job in which an image is printed on plural sheets of paper, the control unit controls the roller members to perform the detection-unit-cleaning mode on a final sheet of paper in the printing job.

It is desirable to provide the transporting device wherein the control unit controls the roller members to perform the detection-unit-cleaning mode just before a process enters into a stabilizing process step performed during a period of image forming time.

It is desirable to provide the transporting device wherein the control unit controls the roller members to perform the detection-unit-cleaning mode every predetermined set sheets of paper.

It is desirable to provide the transporting device wherein the control unit performs a control of leaving a larger space between the transported sheets of paper when performing the detection-unit-cleaning mode than that when performing a normal offset correction mode in which the roller members move to the second direction to perform a correction of the positional deflection of the sheet of paper.

It is desirable to provide the transporting device wherein the control unit performs a control of making the moving positions of the sheets of paper differ from each other every predetermined performed times of the detection-unit-cleaning mode when moving the sheets of paper to an outside position from the image forming position and the position of the side end of the sheet of paper during the detection-unit-cleaning mode.

It is desirable to provide an image forming device including the above-mentioned transporting device.

On the embodiment of the transporting device according to the invention, in the detection-unit-cleaning mode, the detection unit detects a side end of the sheet of paper with respect to an end of the image forming position, which is a previously set position, corresponding to the side end of the sheet of paper. The control unit determines if the side end of the sheet of paper detected by the detection unit stays inside the end of the image forming position (a center side of the end of the image forming position) based on a difference between the end of the image forming position and the side end of the sheet of transporting paper. If so, the control unit controls the roller members to move so that the side end of the sheet of paper moves to an outside position from the end of the image forming position and then to meet the side end of the sheet of paper to the previously set image forming position. Further, the control unit determines if the side end of the sheet of paper detected by the detection unit stays outside the end of the image forming position or on the end of the image forming position. If so, the control unit controls the roller members to move so that the side end of the sheet of paper moves to an outside position from the passed position of sheet of paper (side end of the sheet of paper) and then to meet the side end of the sheet of paper to the previously set image forming position.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIGS. 1A through 1D are diagrams showing detection examples of a side end of a sheet of paper using a conventional line sensor;

FIG. 2 is a drawing showing a configuration example of an image forming apparatus according to an embodiment of this invention;

FIG. 3 is a perspective view of a transporting device showing a configuration example thereof as an embodiment of this invention;

FIG. 4 is a sectional view of a line sensor and shift rollers showing a configuration example thereof (Part one);

FIG. 5 is a sectional view of the line sensor and shift rollers showing the configuration example thereof (Part two);

FIG. 6 is a block diagram illustrating a configuration example of the image forming apparatus;

FIG. 7 is a flowchart showing an operation example of the image forming apparatus;

FIGS. 8A through 8C are drawings illustrating moving example of a sheet of paper under the line-sensor-cleaning mode (Part one);

FIGS. 9A through 9C are drawings illustrating the moving example of the sheet of paper under the line-sensor-cleaning mode (Part two); and

FIGS. 10A through 10C are drawings illustrating the moving example of the sheet of paper under the line-sensor-cleaning mode (Part three).

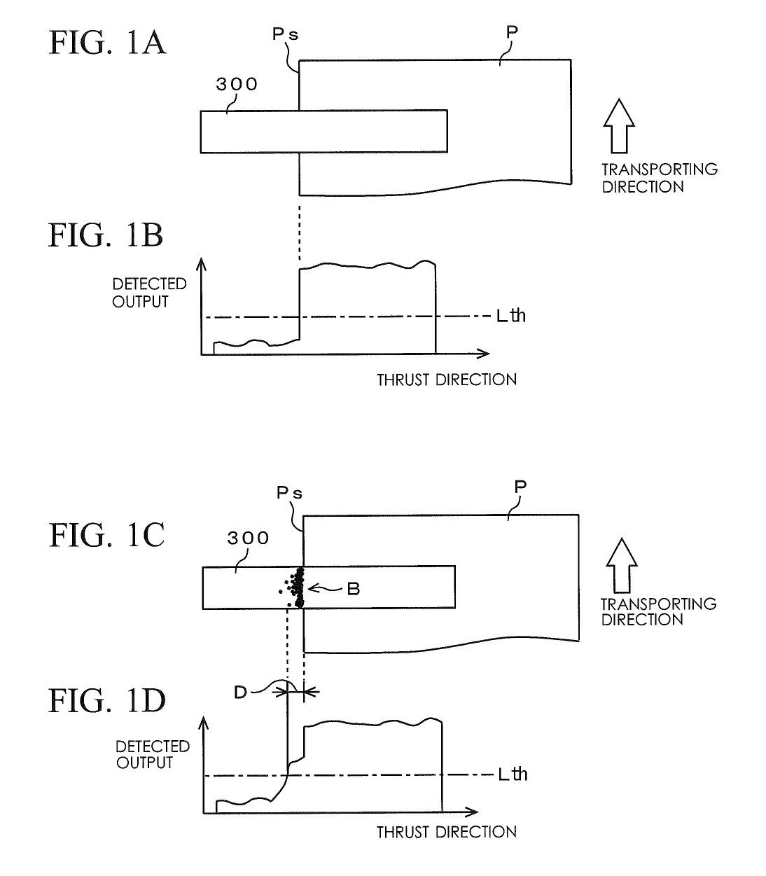

### DESCRIPTION OF THE PREFERRED EMBODIMENTS

The following will describe embodiments of a transporting device and an image forming apparatus using the same relating to the invention with reference to drawings.

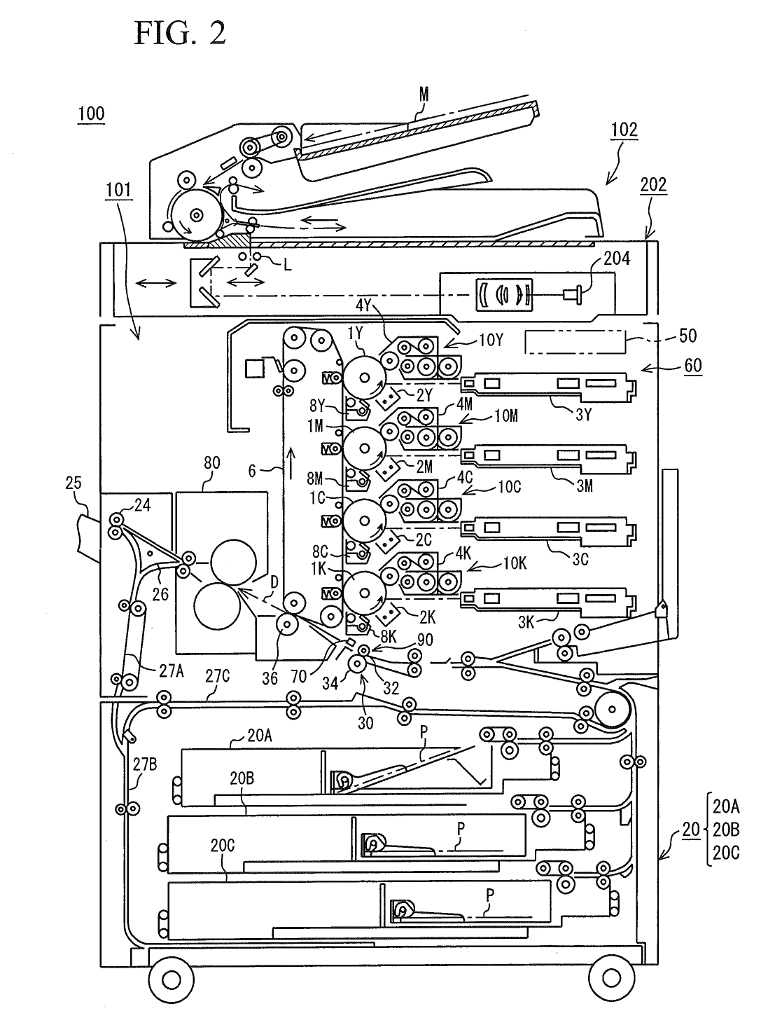

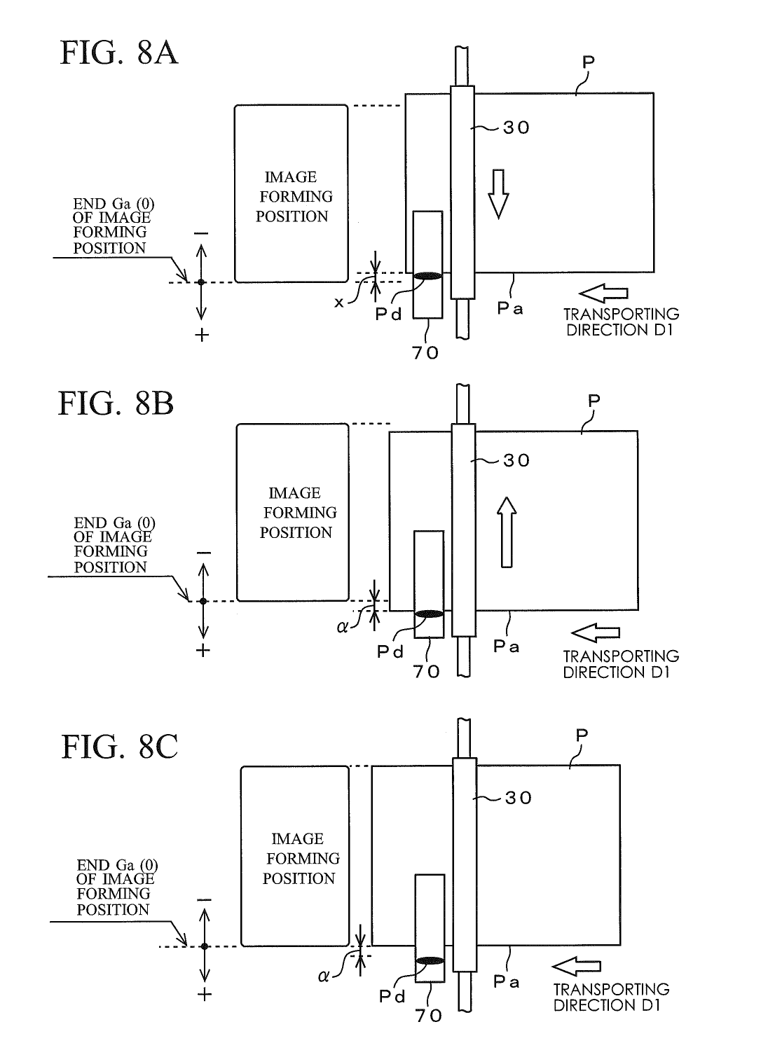

FIG. 2 schematically shows a configuration example of the image forming apparatus 100 according to a first embodiment of this invention. The image forming apparatus 100 according to a first embodiment of this invention has a positional deflection correction mode (offset correction mode) in which a deflection of a position of the sheet of paper P is normally corrected, and a line-sensor-cleaning mode (detection-unit-cleaning mode) which is performed under a predetermined condition. The line-sensor-cleaning mode is a mode having both of a function for correcting a deflection of a position of the sheet of paper P and a function for cleaning paper dust (see FIGS. 8A through 8C) adhered to a line sensor 70.

The image forming apparatus 100 is referred to as “an image forming apparatus of tandem type” as shown in FIG. 2. The image forming apparatus 100 contains a main body 101 of the image forming apparatus and an automatic document feeder 102 mounted on the main body 101. The automatic document feeder 102 feeds the documents M, which is mounted on the document mounter, on a one-by-one basis to the main body 101 of the image forming apparatus with them being separated.

The main body 101 of the image forming apparatus contains a document-reading unit 202, image forming units 10Y, 10M, 10C and 10K, an intermediate transfer belt 6, a transporting unit 90, secondary transfer rollers 36, a feeder 20 and a fixing unit 80. The transporting unit 90 contains at least a controller 50, shift rollers 30 and a line sensor 70. Further, the image forming units 10Y, 10M, 10C and 10K, the intermediate transfer belt 6 and the secondary transfer rollers 36 constitute an example of an image forming device 60.

The document-reading unit 202 irradiates light onto an image of the document M at a document image reading position through a lamp L and receives light reflected thereby to focus on an image pickup device 204 such as charge-couple device (CCD) through a mirror unit. The image pickup device 204 receives the light and converts it to an electric image signal which is output to the controller 50. The controller 50 performs various kinds of processing such as A/D conversion, shading compensation, compression and the like on the image signal to generate any image data.

The image forming unit 10Y contains a charging portion 2Y, an exposing portion 3Y, a developing portion 4Y, a photosensitive drum 1Y and a cleaning portion 8Y. The charging portion 2Y charges a static charge uniformly around a surface of the photosensitive drum 1Y. The exposing portion 3Y is composed of a laser source, polygon mirror, plural lenses and the like, which are not shown. The exposing portion 3Y scans a surface of the photosensitive drum 1Y using laser beam based on the image data received from the controller 50 to form a latent image which is exposed by the laser beam to lose its static charge. The developing portion 4Y develops the latent image using yellow toner Y to affix it to a charge-lost latent image area on the photosensitive drum 1Y, thereby forming a toner image. The cleaning portion 8Y cleans the toner leaved on the surface of the photosensitive drum 1Y which has been transferred the toner.

Other image forming units 10M, 10C and 10K have respectively the same function and configuration as those of the image forming unit 10Y. The developing portions 4M, 4C and 4K develop the latent images on the photosensitive drums 1M, 1C and 1K using magenta toner M, cyan toner C and black toner K respectively to affix them to charge-lost latent image areas on the photosensitive drums 1M, 1C and 1K, thereby forming their toner images. Respective toner images formed on the photosensitive drums 1Y, 1M, 1C and 1K are transferred to the endless intermediate transfer belt 6 so that the images are overlapped at their predetermined locations, thereby forming a color image on the intermediate transfer belt 6.

The feeder 20 is provided with plural feeding trays 20A, 20B and 20C. The feeder 20 sends the sheet of paper P, which is selected by a user, from each of the feeding trays 20A, 20B and 20C by the transporting rollers and transports it to the shift rollers 30.

The shift rollers 30 are positioned upstream to the secondary transfer rollers 36 on a transporting route and perform a correction of the sheet of inclined paper P or the like so that the sheet of paper P is looped by colliding a forward end of the sheet of paper P fed from the feeder 20 with them. The shift rollers 30 also move to a direction D2 (hereinafter, referred to as “thrust direction (or second direction)) which is perpendicular to a transporting direction D1 (first direction) of the sheet of paper P with the sheet of paper being held between them and move the sheet of paper P to an image forming position thereof previously set. The line sensor is positioned downstream to the shift rollers 30 along a transporting direction of the sheet of paper P and detects a difference (an amount of positional deflection) between a position of the sheet of paper P passed through the shift rollers 30 and the image forming position.

The sheet of paper P, a position of which is corrected by the shift rollers 30, is transported to the secondary transfer portion at a fixed timing. The sheet of paper P is brought into contact with the intermediate transfer belt 6 and a color image formed by overlapping respective toner images on the intermediate transfer belt 6 is transferred to the sheet of paper P. The sheet of paper P to which the color image is transferred is transported to the fixing portion 80 by the secondary transfer rollers 36 or the like. The fixing portion 80 contains a heater and fixes the color image (non-toner image) on the sheet of paper P by applying pressure to the sheet of paper P and/or heating the same. The fixed sheet of paper P is ejected by paper ejection rollers 24 to a paper ejection tray 25.

When images are formed on both sides of the sheet of paper P, the sheet of paper P, on a surface of which the image has already been formed, is transported into a loop path 27A via diverging paths 26, inverted in the inverting portion 27B and then, transported to the secondary transfer portion again via a re-feeding path 27C. In the secondary transfer portion, the other image is transferred to a back surface of the sheet of paper P and then, ejected to the paper ejection tray 25 via the fixing unit 80.

### [Configuration Example of Line Sensor]

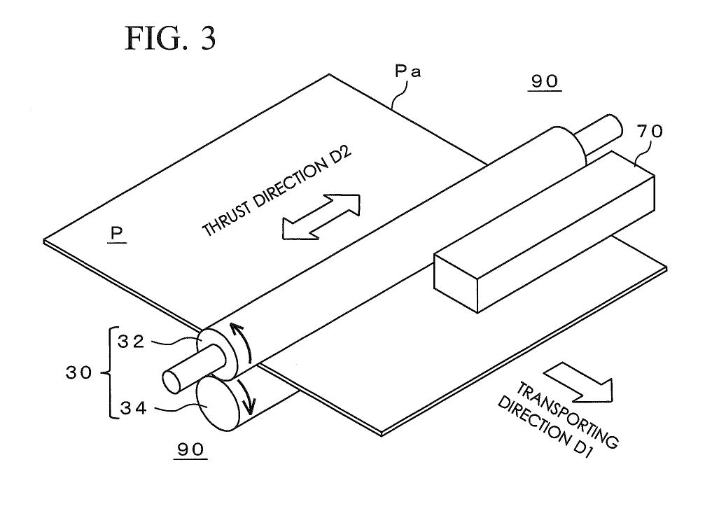

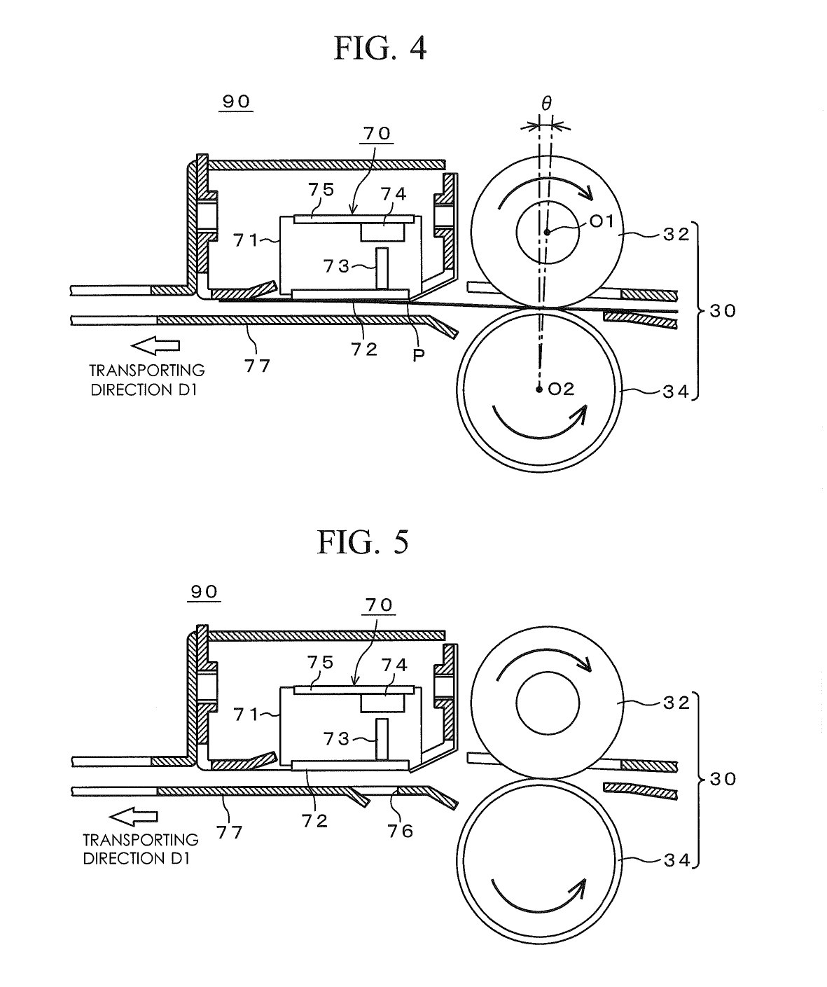

FIG. 3 shows a configuration example of the line sensor 70 and the shift rollers 30, which constitute an embodiment of the transporting device 90 according to this invention. FIGS. 4 and 5 show a sectional configuration example of the line sensor 70 and the shift rollers 30, which constitute the embodiment of the transporting device 90 according to this invention.

The line sensor 70 will be first described. As shown in FIGS. 3 and 4, the line sensor 70 is composed of plural CODS 74 which are arranged so as to be put side by side. An arranged direction of CODS 74 extends along the thrust direction D2 which is perpendicular to the transporting direction D1. These CODS 74 are also arranged so as to extend beyond a side end Pa of the sheet of paper P on a width direction thereof. It is to be noted that the line sensor 70 constitutes the detection unit.

The line sensor 70 has a long housing 71 which extends along the thrust direction D2, as shown in FIG. 3. A contact glass 72, a lens 73, CCDS 74 and a substrate 75 are incorporated inside the housing 71. The contact glass 72 is attached to a lower surface of the housing 71 so that it exposes the transporting route. The contact glass 72 functions as a member to allow light to be incident therethrough and as a cover member. The CCDS 74 are positioned over the contact glass 72 and the lens 73. The CCDS 74 converts light, which is reflected by the sheet of paper P and the opposed guide plate and is incident through the contact glass 72 and the lens 73, into an electric signal and outputs the converted electric signal to the substrate 75. The substrate 75 supplies to the controller 50 the electric signal based on any difference between the contrast of the sheet of paper P and the contrast of the opposed guide plate.

The guide plate 77 arranged so as to be opposed to the line sensor 70 is black. The line sensor 70 detects difference between the contrast of side end Pa of the sheet of passing paper P and the contrast of the black opposed guide plate 77. This enables the line sensor 70 to measure a position of the side end Pa of the sheet of paper P. It is to be noted that, as shown in FIG. 5, an opening 76 may be pierced in the opposed guide plate 77 which is opposed to the lens 73 of the line sensor 70, not the opposed guide plate 77 being made black. Such a configuration enables the line sensor 70 to detect the side end Pa of the sheet of paper P based on the difference between the contrast of side end Pa of the sheet of passing paper P and the contrast of the guide plate 77.

### [Configuration Example of Shift Rollers]

The following will describe the shift rollers 30. The shift rollers 30 constitute roller members and have a driving roller 34 and a driven roller 32. The driving roller 34 connects a driving motor 40 for shift rollers, which will be described later, and rotates according to a driving of the driving motor 40 for shift rollers. The driven roller 32 comes into contact with a circumferential surface of the driving roller 34 and rotates according to the rotation of the driving roller 34. Accordingly, the driving roller 34 and the driven roller 32 enable the sheet of paper P to be transported with it being held therebetween.

The shift rollers 30 also connect a motor 42 for thrust moving, which will be described later, and reciprocate on the thrust direction D2 by driving of this motor 42 for thrust moving with the sheet of paper P being held therebetween. The driven roller 32 also connects a shift-rollers-contacting mechanism 44, which will be described later, and is brought into contact with the driving roller 34 or releases their contact to prepare receiving the next sheet of paper.

Here, in this embodiment, the driven roller 32 is arranged so that it comes into contact with the circumferential surface of the driving roller 34 with a center O1 of the driven roller 32 being shifted from a center O2 of the driving roller 34 to upstream side by an angle θ on the transporting direction D1, not perpendicular to the center O2 of the driving roller 34. Namely, the driven roller 32 is shifted to the driving roller 34 so that a tangential line of the driving roller 34 and the driven roller 32 is inclined, not on the level, with a downstream end of the tangential line in the transporting direction D1 facing the line sensor 70 positioned upwards. This enables a forward end of the sheet of paper P to be contacted with or approached to a surface of the contact glass 72 of the line sensor 70 when the sheet of paper P is held between the driving roller 34 and the driven roller 32 during the transportation of the sheet of paper P. As a result thereof, in the line-sensor-cleaning mode, when the sheet of paper P moves to the thrust direction D2, by the side end Pa of the sheet of paper P, the paper dust adhered to a surface of the contact glass 72 is directly cleaned out and removed.

Alternatively, by arranging the driven roller 32 so that it is perpendicular to the driving roller 34, not shifted to the driving roller 34, the sheet of paper P may be transported without contacting or approaching a forward end of the sheet of paper P with or to the contact glass 72 of the line sensor 70. Even in this case, it is possible to move the paper dust adhered to the surface of the contact glass 72 sufficiently outside the contact glass 72 or remove the paper dust by a wind or the like generated when the sheet of paper P moves to the thrust direction D2.

### [Configuration Example of Image Forming Apparatus]

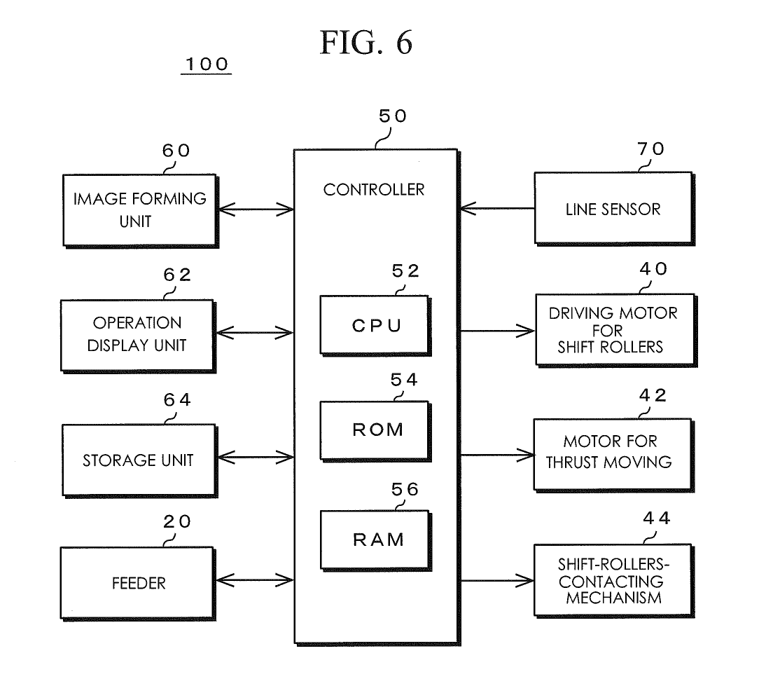

FIG. 6 illustrates a configuration example of the image forming apparatus 100. As shown in FIG. 6, the image forming apparatus 100 contains a controller controlling an operation of whole of the image forming apparatus 100. The controller 50 includes a central processing unit (CPU) 52, a read only memory (ROM) 54, a random access memory (RAM) 56 and the like. CPU 52 performs image forming processing and/or the line-sensor-cleaning mode by reading any programs stored in ROM 54 and extracting the programs to precede with them.

The controller 50 connects the image forming unit 60, an operation display unit 62, a storage unit 64, the feeder 20, the line sensor 70, the driving motor 40 for shift rollers, the motor 42 for thrust moving and a shift-rollers-contacting mechanism 44, respectively.

The operation display unit 62 is composed of, for example, a touch panel of capacitive sensing system or resistive film system. The operation display unit 62 detects input information based on any input operations by a user and supplies an operation signal to the controller 50. For example, the operation display unit 62 sets a start condition of the line-sensor-cleaning mode, receives any random settings such that a moved position of the shift rollers to the outside changes during the line-sensor-cleaning mode, and sets various kinds of conditions of image forming processing to supply the operation signals based on these pieces of input information to the controller 50. A moved amount of the shift rollers 30 during the line-sensor-cleaning mode may be set by inputting the distance to be really moved of the side end Pa of the sheet of paper P or by calculating a random value automatically in the controller 50 and using the same.

The storage unit 64 is composed of, for example, a semiconductor memory, a hard disk drive (HDD) and the like. The storage unit 64 stores any control values or the like to be read during the line-sensor-cleaning mode. The image forming unit 60 is provided with, for example, the intermediate transfer belt 6 and the like and performs any image forming processing based on the control information received from the controller 50. The feeder 20 feeds to the image forming unit 60 the sheet of paper P corresponding to any paper-size information input from the operation display unit 62 or the like based on the paper-size information.

The line sensor 70 detects the side end Pa of the sheet of paper P transported to the secondary transfer portion from the shift rollers 30 and supplies to the controller 50 a detection signal obtained by this detection.

The driving motor 40 for shift rollers is composed of, for example, a stepping motor or the like. The driving motor 40 for shift rollers drives based on a driving signal received from the controller 50 to rotate or stop the shift rollers 30. This enables an oblique movement of the sheet of paper P to be compensated by striking the sheet of paper P onto the shift rollers 30 to form a loop.

The Motor 42 for thrust moving is composed of, for example, a stepping motor or the like. The Motor 42 for thrust moving drives based on a driving signal received from the controller 50 to move the shift rollers 30 to the thrust direction D2 through any driving transmission means such as gear mechanism. This enables the sheet of paper P to move to a predetermined image forming position and offset of the sheet of paper P to be corrected.

The shift-rollers-contacting mechanism 44 is composed of, for example, a solenoid, a motor and the like. The shift-rollers-contacting mechanism 44 allows the driven roller 32 to come into contact with the driving roller 34 under a pressure or allows the driven roller 32 to release the contact with the driving roller 34. This enables the sheet of paper P to move to the thrust direction D2 with the sheet of paper being held between the shift rollers 30 when correcting offset of the sheet of paper P. This also enables the sheet of paper P to be release from the condition wherein the sheet of paper P is held between the shift rollers 30 when the sheet of paper P is transported to the secondary transfer rollers 36, thereby allowing the next sheet of paper P to be received.

The controller 50 performs the offset correction mode during the image forming time. The controller 50 obtains positional deflection information of the side end Pa of the sheet of paper P, which has been detected by the line sensor 70, from the line sensor 70. The controller 50 then calculates difference between this positional deflection information and the information on the end position, which has been previously set, of the side end Pa of the sheet of paper P and controls the shift rollers 30 to move to the thrust direction D2 by an amount of this difference, thereby enabling the sheet of paper P to move to the image forming position previously set. In this embodiment, the image forming position indicates to a position in which the image is transferred in the image forming unit 60 and is previously set based on a case wherein the sheet of paper P is transported based on a center of the transporting route. Of course, the image forming position may be set based on a case wherein the sheet of paper P is transported based on a side of the transporting route.

The controller 50 performs the line-sensor-cleaning mode when the image forming process meets a previously set condition. For example, when a user requests a printing job in which an image is printed on plural sheets of paper, the controller 50 performs the line-sensor-cleaning mode when the image is printed on a final sheet of paper in the printing job. Further, the controller 50 performs the line-sensor-cleaning mode just before the image forming apparatus 100 enters into a stabilizing process step such as color shift correction and density correction. The controller 50 performs the line-sensor-cleaning mode every predetermined set sheets of paper, which have been previously set. Performing the line-sensor-cleaning mode at such timing allows the transporting device to be correspondingly used in the image forming apparatus 100 which has a fast printing speed.

When the operation mode is changed to the line-sensor-cleaning mode, the controller 50 controls the shift rollers 30 to move the sheet of paper P to an outside position from an end Ga of the image forming position and a position of the side end Pa of the sheet of paper P when the sheet of paper P passes through the line sensor 70, and then to move the sheet of paper P to the previously set image forming position. On the other hand, when the operation mode is a normal mode (offset correction mode), the controller 50 controls the shift rollers 30 to move the sheet of paper P which has been deflected to the previously set image forming position. When the random setting is selected on the operation display unit 62, the controller 50 controls the shift rollers 30 to perform a control of making the moving position of the side end Pa of the sheet of paper P differ every time or every predetermined performed times of the line-sensor-cleaning mode.

Further, the controller 50 obtains positional deflection information of the side end Pa of the sheet of paper P, which has been detected by the line sensor 70, from the line sensor 70. The controller 50 then calculates difference between this positional deflection information and the information on the end position, which has been previously set, of the side end Pa of the sheet of paper P. The controller 50 additionally controls the shift rollers 30 to move to the thrust direction D2 by an amount of this difference, thereby enabling the sheet of paper P to move to the image forming position.

### [Example of Operation of Controller in Image Forming Apparatus]

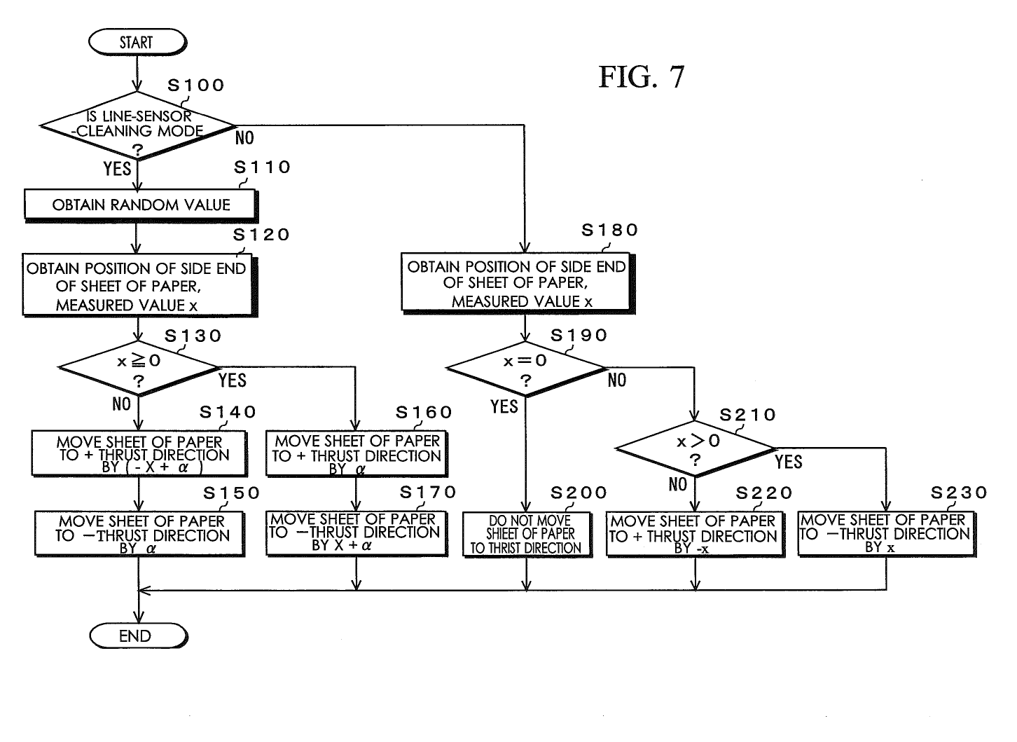

The following will describe an operation of the controller 50 in this embodiment of the image forming apparatus 100. FIG. 7 is a flowchart showing an operation example of the controller 50 in the image forming apparatus 100. It is to be noted that in FIGS. 8A through 10C, a position of the end Ga of the image forming position, which has been previously set, is set to be zero, an outside direction from this end Ga is set to be plus direction and an inside direction from this end Ga is set to be minus direction.

As shown in FIG. 7, at a step S100, the controller 50 determines if the image forming processing meets a start condition of the line-sensor-cleaning mode. For example, if the user requests the printing job to print plural sheets of paper, the controller 50 determines that the image forming processing meets the start condition of the line-sensor-cleaning mode when the final sheet of paper in the printing job is printed. If the controller 50 determines that the image forming processing meets the start condition of the line-sensor-cleaning mode, then the controller 50 goes to a step S110. If not, then the controller 50 goes to a step S180.

At the a step S110, if a random setting is performed in the line-sensor-cleaning mode, the controller 50 obtains a random value a from the storage unit 64. When obtaining the random value α, the controller 50 goes to a step S120.

At the step S120, the controller 50 performs the line-sensor-cleaning mode to obtain a measured value x (positional information), which is detected by the line sensor 70, of the side end Pa of the final sheet of paper P in the printing job. The measured value x is an amount of positional deflection, which indicates what degree does the side end Pa of the final sheet of paper P deflect from the end Ga of the image forming position on either plus or minus direction. When obtaining the measured value x, the controller 50 goes to a step S130.

At the step S130, the controller 50 determines if the measured value x of the sheet of paper P obtained from the line sensor 70 exceeds zero when the end Ga of the image forming position is set to be zero. If the controller 50 determines that the measured value x of the sheet of paper P does not exceed zero, to minus direction, then the controller 50 goes to a step S140. For example, if so, the side end Pa of the sheet of paper P passes inside the end Ga of the image forming position, as shown in FIG. 8A. In this moment, paper dust Pd adheres to, for example, a portion of the contact glass 72, which is outside of the side end Pa of the sheet of paper P.

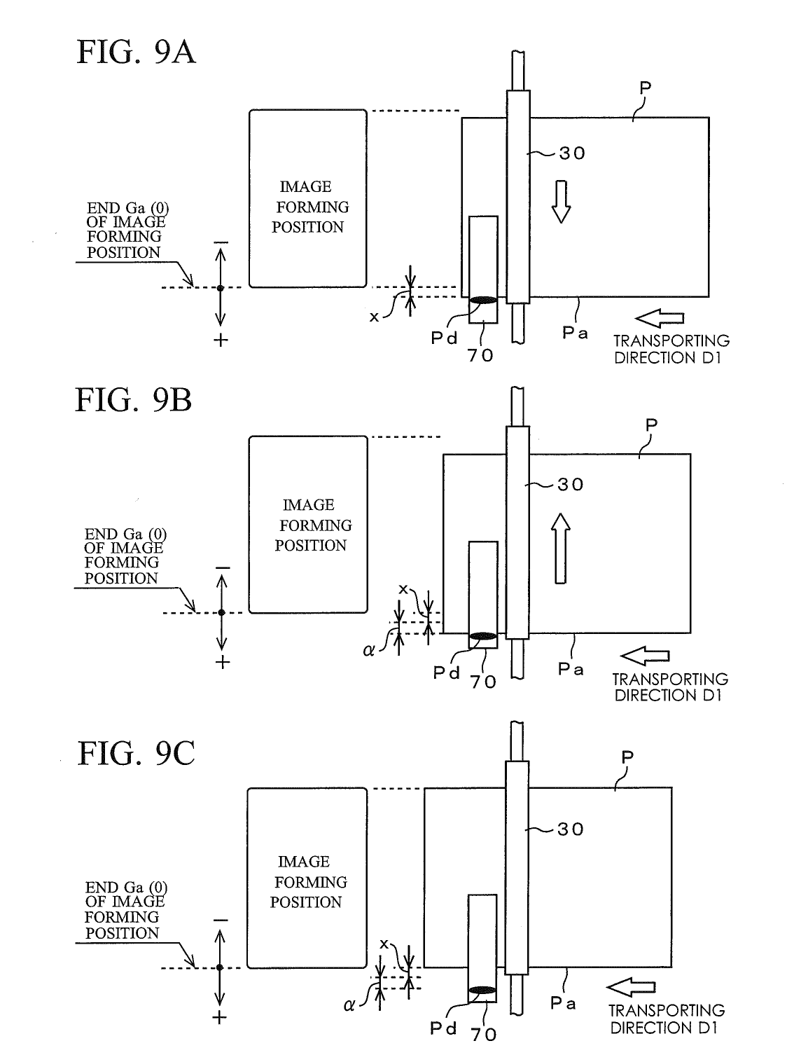

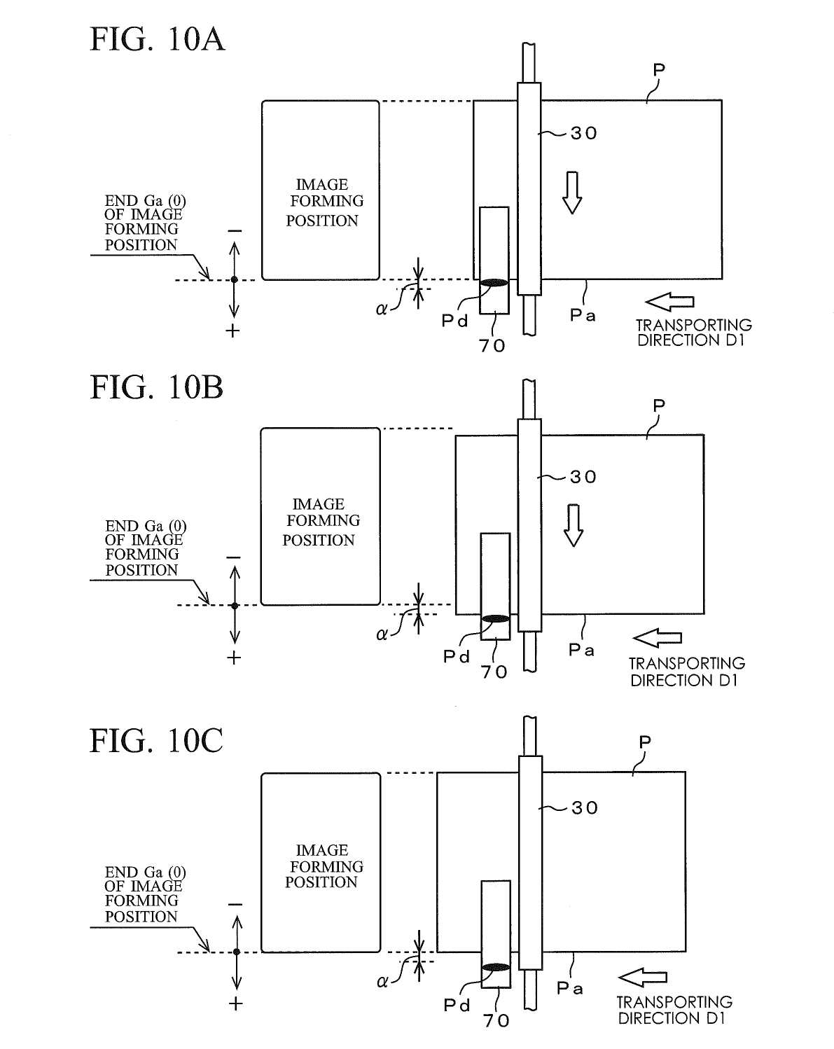

On the other hand, if the controller 50 determines that the measured value x of the sheet of paper P exceeds zero, to plus direction, then the controller 50 goes to a step S160. For example, if so, the side end Pa of the sheet of paper P passes outside the end Ga of the image forming position, as shown in FIG. 9A or the side end Pa of the sheet of paper P passes through the end Ga of the image forming position (without any positional deflection), as shown in FIG. 10A. In a case shown in FIG. 9A, paper dust Pd adheres to, for example, a portion of the contact glass 72, which is outside of the side end Pa of the sheet of paper P.

In a case shown in FIG. 10A, paper dust Pd adheres to, for example, a portion of the contact glass 72, which is outside of the side end Pa of the sheet of paper P and corresponds to the end Ga of the image forming position.

At the step S140, when the side end Pa of the sheet of paper P passes inside the end Ga of the image forming position, the controller 50 controls the motor 42 for thrust moving to drive and controls the shift rollers 30 to move toward the plus direction by a thrust amount of (−x+α) with the sheet of paper P being held between the shift rollers 30. For example, as shown in FIG. 8B, the controller 50 controls the shift rollers 30 to move toward the plus direction by a thrust amount of (−x) so that the side end Pa of the sheet of paper P moves to the image forming position, and then, the controller 50 controls the shift rollers 30 to move toward the plus direction by a thrust amount of (+α) from the image forming position so that the side end Pa of the sheet of paper P moves outside the end Ga of the image forming position. This enables the paper dust Pd adhered to the contact glass 72 to be swept outside the side end Pa of the sheet of paper P and the end Ga of the image forming position. When moving the sheet of paper P, the controller 50 goes to a step S150.

At the step S150, the controller 50 controls the motor 42 for thrust moving to drive and controls the shift rollers 30 to move toward the minus direction by a thrust amount of (a) with the sheet of paper P being held between the shift rollers 30 so that the sheet of paper P moves back to the previously set image forming position to correct the positional deflection. For example, as shown in FIG. 8C, the controller 50 controls the shift rollers 30 to move toward the minus direction by a thrust amount of (α) so that the side end Pa of the sheet of paper P meets the end Ga of the image forming position to correct the positional deflection of the sheet of paper P.

Further, when the side end Pa of the sheet of paper P passes outside the end Ga of the image forming position or the side end Pa of the sheet of paper P passes through the end Ga of the image forming position, at the step S160, the controller 50 controls the motor 42 for thrust moving to drive and controls the shift rollers 30 to move toward the plus direction by a thrust amount of (α) with the sheet of paper P being held between the shift rollers 30. For example, as shown in FIGS. 9B and 10B, the controller 50 controls the shift rollers 30 to move outside from the image forming position toward the plus direction by the thrust amount of (α) so that the side end Pa of the sheet of paper P moves outside the side end Pa of the sheet of paper P when it passes through the line sensor 70 and the end Ga of the image forming position. This enables the paper dust Pd adhered to the contact glass 72 to be swept outside the side end Pa of the sheet of paper P when it passes through the line sensor 70 and the end Ga of the image forming position. When moving the sheet of paper P, the controller 50 goes to a step S170.

At the step S170, the controller 50 controls the motor 42 for thrust moving to drive and controls the shift rollers 30 to move toward the minus direction by a thrust amount of (x+α) with the sheet of paper P being held between the shift rollers 30 so that the sheet of paper P moves back to the previously set image forming position to correct the positional deflection. For example, as shown in FIG. 9C, the controller 50 controls the shift rollers 30 to move toward the minus direction by a thrust amount of (x+α) so that the side end Pa of the sheet of paper P meets the end Ga of the image forming position to correct the positional deflection of the sheet of paper P. When the sheet of paper P is not deflected from the image forming position, as shown in FIG. 10C, the controller 50 controls the shift rollers 30 to move toward the minus direction by a thrust amount of (α) to correct the positional deflection of the sheet of paper P because the measured value x is zero. According to a series of these operations, the controller 50 performs the line-sensor-cleaning mode.

At the step S100, if the controller 50 determines that the image forming processing does not meet the start condition of the line-sensor-cleaning mode, then the controller 50 performs a normal offset correction mode. At the step S180, the controller 50 obtains a measured value x, which is detected by the line sensor 70, of the side end Pa of the final sheet of paper P in the printing job. When obtaining the measured value x, the controller 50 goes to a step S190.

At the step S190, the controller 50 determines if the measured value x of the final sheet of paper P, which is detected by the line sensor 70, is zero. If the controller 50 determines that the measured value x of the final sheet of paper P, which is detected by the line sensor 70, is zero, then the controller 50 determines that any offset (positional deflection) does not occur in the sheet of paper P and goes to a step S200. On the other hand, if the controller 50 determines that the measured value x of the final sheet of paper P is not zero, then the controller 50 goes to a step S210.

At the step S200, since the measured value x of the final sheet of paper P is zero and any offset correction of the sheet of paper P is not required, the controller 50 does not control the shift roller 30 to move to the thrust direction but controls the shift roller 30 to allow the sheet of paper P to be transported to the secondary transfer portion with it being held between the shift rollers 30.

When the controller 50 determines that the measured value x of the final sheet of paper P is not zero, the controller 50 determines if the measured value x of the final sheet of paper P, which is obtained from the line sensor 70, exceeds zero at the step S210. If the controller 50 determines that the measured value x of the final sheet of paper P does not exceed zero and minus value, the controller 50 goes to a step S220. If the controller 50 determines that the measured value x of the final sheet of paper P does not exceed zero and plus value, the controller 50 goes to a step S230.

At the step S220, the controller 50 controls the motor 42 for thrust moving to drive and controls the shift rollers 30 to move toward the plus direction by a thrust amount of (−x) with the sheet of paper P being held between the shift rollers 30 so that the side end Pa of the sheet of paper P moves to the previously set image forming position to correct the positional deflection.

At the step S230, the controller 50 controls the motor 42 for thrust moving to drive and controls the shift rollers 30 to move toward the minus direction by a thrust amount of (x) with the sheet of paper P being held between the shift rollers 30 so that the side end Pa of the sheet of paper P moves to the previously set image forming position to correct the positional deflection. According to a series of these operations, the controller 50 performs the offset correction mode.

As described above, according to the above-mentioned embodiments of the transporting device and the image forming apparatus, in the line-sensor-cleaning mode, the side end Pa of the sheet of paper P moves outside the position of the side end Pa of the sheet of paper P when the sheet of paper P passes through the line sensor 70 and the end Ga of the image forming position so that the transporting device and the image forming apparatus can remove any paper dust adhered to the portion of the contact glass near the side end Pa of the sheet of passed paper P directly (by contact) or indirectly (by wind or the like). Thus, the transporting device and the image forming apparatus according to the invention may prevent the line sensor 70 from erroneously detecting a position of the side end Pa of the sheet of paper P effectively and enable the line sensor 70 to detect the position of the side end Pa of the sheet of paper P with high accuracy. As a result thereof, the sheet of paper P may be moved back to the image forming position accurately, which results in that an image is formed with high accuracy.

Further, the transporting device and the image forming apparatus according to the invention may remove the paper dust without adding any new mechanical configuration. This avoids a complicated design which causes to be increased the costs in manufacture.

Additionally, the transporting device and the image forming apparatus according to the invention may perform the line-sensor-cleaning mode without degrading their productivity by performing the line-sensor-cleaning mode on the final sheet of paper in the printing job or just before the stabilizing process step. Since it is not required in the transporting device and the image forming apparatus according to the invention that the paper guide plate is opened or closed by hand in a cleaning time as described in Japanese Patent No. 3758418, they may perform the line-sensor-cleaning mode without any inconvenient operations.

Since the transporting device and the image forming apparatus according to the invention make the moving position of the side end Pa of the sheet of paper P when moving the sheet of paper P to an outside position differ during the detection-unit-cleaning mode, it is possible to prevent the paper dust swept out by the sheet of paper P from being concentrated into one position. This enables the line sensor 70 to detect the position of sheet of paper P accurately.

This invention is applicable to the transporting device which is capable of correcting the offset of the sheet of transporting paper and the image forming apparatus using the same.

Although the present invention has been described with reference to the embodiments above, it is to be noted that various changes and modifications are possible to those who are skilled in the art. For example, the controller 50 may perform a control of leaving a larger space between the sheets of transported paper when performing the detection-unit-cleaning mode than that when performing a normal offset correction mode. This is because it requires any time for operations such that the sheet of paper P moves outside and then, it moves back to the image forming position, in addition to the normal offset correction, in the line-sensor-cleaning mode. Although the random value has been set so that the moving position of the sheet of paper P differs in the above embodiments, the random value may be fixed and the sheet of paper P may move so that the side end Pa of the sheet of paper P passes through the same position every time. This is because an effect of preventing the line sensor from erroneously detecting the position of the side end of the sheet of paper may be given by removing the paper dust Pd on the contact glass 72 by means of the side end Pa of the sheet of paper P when the sheet of paper P passes therethrough.

It should be understood by those skilled in the art that various modifications, combinations, sub-combinations and alterations may occur depending on design requirements and other factors insofar as they are within the scope of the appended claims or the equivalents thereof.

What is claimed is:

1. A transporting device that transports a sheet of paper comprising:
a detection unit that detects a side end of the sheet of paper, which is transporting on a first direction, along a second direction which is perpendicular to the first direction;
a control unit that calculates information on a positional deflection from a previously set image forming position of the sheet of paper based on positional information on the side end of the sheet of paper, which is detected by the detection unit, an image being formed on the image forming position, and positional information on the image forming position; and
roller members that move to the second direction with the sheet of paper being held between them based on the information on the positional deflection, which is calculated by the control unit, the roller members being positioned upstream to the detection unit along a direction of transporting the sheet of paper,
wherein the control unit has a detection-unit-cleaning mode in which when the roller members move to the second direction to perform a correction of the positional deflection of the sheet of paper, the control unit controls the roller members to move the sheet of paper to an outside position from the image forming position and a position of the side end of the sheet of paper when the sheet of paper passes through the detection unit, and then to move the sheet of paper to the image forming position, based on the image forming position and the position of the side end of the sheet of paper, which is detected by the detection unit.

2. The transporting device according to claim 1 wherein the detection unit has a cover member that is positioned at a side of a transporting route of the sheet of paper, and
wherein the roller members move the sheet of paper with the sheet of paper being held therebetween so that the sheet of paper comes into contact with the cover member or is close to the cover member when moving the sheet of paper to the second direction.

3. The transporting device according to claim 1 wherein when a printing job is a job in which an image is printed on plural sheets of paper, the control unit controls the roller members to perform the detection-unit-cleaning mode on a final sheet of paper in the printing job.

4. The transporting device according to claim 1 wherein the control unit controls the roller members to perform the detection-unit-cleaning mode just before a process enters into a stabilizing process step performed during a period of image forming time.

5. The transporting device according to claim 1 wherein the control unit controls the roller members to perform the detection-unit-cleaning mode every predetermined set sheets of paper.

6. The transporting device according to claim 1 wherein the control unit performs a control of leaving a larger space between the transported sheets of paper when performing the detection-unit-cleaning mode than that when performing a normal offset correction mode in which the roller members move to the second direction to perform a correction of the positional deflection of the sheet of paper.

7. The transporting device according to claim 1 wherein the control unit performs a control of making the moving positions of the sheets of paper differ from each other every predetermined performed times of the detection-unit-cleaning mode when moving the sheets of paper to an outside position from the image forming position and the position of the side end of the sheet of paper during the detection-unit-cleaning mode.

8. An image forming apparatus comprising:
an image forming device that forms an image on a sheet of paper; and
a transporting device that transports the sheet of paper,
the transporting device includes:
a detection unit that detects a side end of the sheet of paper, which is transporting on a first direction, along a second direction which is perpendicular to the first direction;
a control unit that calculates information on a positional deflection from a previously set image forming position of the sheet of paper based on positional information on the side end of the sheet of paper, which is detected by the detection unit, an image being formed on the image forming position, and positional information on the image forming position; and
roller members that move to the second direction with the sheet of paper being held between them based on the information on the positional deflection, which is calculated by the control unit, the roller members being positioned upstream to the detection unit along a direction of transporting the sheet of paper,
wherein the control unit has a detection-unit-cleaning mode in which when the roller members move to the second direction to perform a correction of the positional deflection of the sheet of paper, the control unit controls the roller members to move the sheet of paper to an outside position from the image forming position and a position of the side end of the sheet of paper when the sheet of paper passes through the detection unit, and then to move the sheet of paper to the image forming position, based on the image forming position and the position of the side end of the sheet of paper, which is detected by the detection unit.

9. The image forming apparatus according to claim 8 wherein the detection unit has a cover member that is positioned at a side of a transporting route of the sheet of paper, and
wherein the roller members move the sheet of paper with the sheet of paper being held therebetween so the sheet of paper comes into contact with the cover member or is close to the cover member when moving the sheet of paper to the second direction.

10. The image forming apparatus according to claim 8 wherein when a printing job is a job in which an image is printed on plural sheets of paper, the control unit controls the roller members to perform the detection-unit-cleaning mode on a final sheet of paper in the printing job.

11. The image forming apparatus according to claim 8 wherein the control unit controls the roller members to perform the detection-unit-cleaning mode just before a process enters into a stabilizing process step performed during a period of image forming time.

12. The image forming apparatus according to claim 8 wherein the control unit controls the roller members to perform the detection-unit-cleaning mode every predetermined set sheets of paper.

13. The image forming apparatus according to claim 8 wherein the control unit performs a control of leaving a larger space between the transported sheets of paper when performing the detection-unit-cleaning mode than that when performing a normal offset correction mode in which the roller members move to the second direction to perform a correction of the positional deflection of the sheet of paper.

14. The image forming apparatus according to claim 8 wherein the control unit performs a control of making the moving positions of the sheets of paper differ from each other every predetermined performed times of the detection-unit-cleaning mode when moving the sheets of paper to an outside position from the image forming position and the position of the side end of the sheet of paper during the detection-unit-cleaning mode.
